(19) United States
(12) Patent Application Publication
(10) Pub. No.: US 2014/0324875 A1
(43) Pub. Date: Oct. 30, 2014

(54) INDEX FOR FAST BATCH UPDATES OF LARGE DATA TABLES

(71) Applicant: KEYW CORPORATION, Hanover, MD (US)

(72) Inventors: David A. GUDEMAN, San Mateo, CA (US); Khoa Duy NGUYEN, San Ramon, CA (US); Ramarao YENDLURI, Fremont, CA (US)

(73) Assignee: KEYW CORPORATION, Hanover, MD (US)

(21) Appl. No.: 13/872,675

(22) Filed: Apr. 29, 2013

(51) Int. Cl. G06F 17/30

(52) U.S. Cl. CPC G06F 17/30336
USPC 707/741

(57) ABSTRACT

Systems and processes for managing data using a composite index formed from a major sub-index and zero or more minor sub-indexes are described. Updates to the data may be cached in memory. When the cache memory becomes full, the contents of the cache may be sorted and stored as entries in a minor sub-index in a hard-disk drive with a single streaming disk write. In response to a threshold condition, the major sub-index may be updated using streaming disk accesses based on the entries in the minor sub-indexes. Once the major sub-index is updated to include all of the updates from the minor sub-indexes, the minor sub-indexes may be deleted.

### BACKGROUND

1. Field

This application relates generally to data management and, more specifically, to systems and processes for storing and retrieving data using indexes.

2. Related Art

Data management systems are often used to store, search, and retrieve large amounts of data. The data may be stored as entries in a “table” containing a set of numbered rows, where each row includes one or more columns of data values of various types. A data structure called an “index” may be used to organize the data entries of the table by mapping each value contained in the set of rows with the row(s) in which that value appears. While useful for producing fast search results, indexes must be managed as data is added, removed, or altered (collectively called “updates” to the index). In applications where the volume and frequency of data updates are very large, managing conventional indexes becomes a costly task that may require expensive, high-speed hardware to operate within reasonable time constraints.

To illustrate, FIG. 1 shows a simplified view of a table 101 and an associated index 103. In this example, table 101 includes four rows of data, with each row containing a unique row identifier (e.g., Row IDs 15, 18, 22, and 23). Each of these rows may include any number N of columns containing various types of data. The data stored in each column may be referred to as a “key” (e.g., keys “abc,” “def,” and “efg”). Index 103 may include a mapping between the keys contained in table 101 and the rows in which they appear. For example, the key “abc” appears in the rows having unique identifiers 15 and 22 of table 101, while keys “def” and “efg” appear in rows 18 and 23, respectively. It should be noted that a single key value in index 103 may be mapped to more than one row in table 101.

Some conventional data management systems may implement index 103 using a B-tree index. In a typical B-tree index, the keys may be stored in nodes of the tree and may be arranged in ascending numerical and/or alphabetical order from left to right. Further, child nodes of a particular node may also be arranged in ascending numerical and/or alphabetical order based on the values of their keys and the values of the keys stored in the parent node separating the adjacent child nodes. Using this type of data structure to implement index 103, nodes containing a desired value can be searched relatively quickly by starting at the root node and navigating down the branches of the tree.

In cases where the index is larger than available memory for storing the index, the index is typically stored primarily on hard-disk storage devices due to their large capacity and low-cost. In these instances, portions of the index may be cached in available memory to improve performance. When portions of the index stored on the hard-disk storage are needed (e.g., when a key is to be added or deleted from the index), a disk caching mechanism may read in a disk page to memory. However, when there is insufficient space in memory to store the page, one or more pages stored in memory may be written to hard-disk storage (e.g., in the case of updates) and removed from memory to free up space for the incoming page. Unfortunately, if the removed page is later needed, it must be loaded back into memory, and some other page in memory must be written to hard-disk storage (e.g., in the case of updates) and removed from memory.

A typical process 200 for updating an index, such as index 103, is illustrated in FIG. 2. Process 200 includes receiving a key to be inserted into the index at block 201. At block 203, a page in which that key is to be inserted is identified. At block 205, it may be determined whether or not that page is currently in memory. If the page is in memory, the process proceeds to block 207 where the key is added to the page. If, however, the page is not in memory, the process proceeds to block 209 where it may be determined whether there is sufficient space in memory for the page determined at block 203. If there is sufficient space, the page is loaded into memory at block 211 and the key is added to that page at block 207. If, however, there is insufficient space for the page, the process may proceed to block 213 where a page from the memory is written to hard-disk and removed from memory to clear space for the page identified at block 203. The page identified at block 203 is then loaded into memory at block 211 and the key is added to the page at block 207. This process 200 may be repeated for each update to the index 103.

In the illustrated example of FIG. 2, the path that includes blocks 201, 203, 205, 209, 213, 211, and 207 represents the steady-state situation where the cache is full and each new item that is inserted or deleted may require a page to be written and another page to be read, where both the read and the write operations may be random access. In cases where the number of rows to be updated is much larger than the number of pages, each page in the index may be read and written many times.

Disk reads and writes are slow compared to memory accesses, and random-access reads and writes are slow compared to streaming reads and writes. Consequently, when used to index data containing a large number of entries and when that data is updated in large batches, the repeated navigation of index 103 using process 200 to maintain the index may result in very slow updating of data.

In addition, B-trees and other index structures designed to be modified in place, typically have large amounts of unused space in them to leave room for new entries. This unused space typically has to be read along with the used space, resulting in slower performance. Additional disk space may also be required to store the index.

Thus, improved management of indexes capable of supporting large updates on large indexes is desired.

### SUMMARY

Processes for indexing data stored in a plurality of rows in a data table are disclosed. In some examples, the process may include storing, in a memory, an update to a row of a data table, wherein the update to the row of the data table is stored as an entry comprising a key and a row identifier associated with the row; sorting a plurality of entries stored in the memory in response to a first threshold condition, wherein the plurality of entries comprises the entry; storing the sorted plurality of entries as a first sub-index; and updating a second sub-index based on a set of first sub-indexes in response to a second threshold condition, wherein the set of first sub-indexes comprises the first sub-index.

In some examples, after updating the second sub-index based on the set of first sub-indexes, the second sub-index may include: a plurality of keys contained in the data table; and one or more lists of row identifiers associated with plurality of keys, wherein the one or more lists of row identifiers comprise row identifiers corresponding to the rows of the data table that include the plurality of keys.

In some examples, the first threshold condition may include insufficient space in the memory to store the update. In other examples, the second threshold condition may include a threshold number of sub-indexes in the set of first sub-indexes, a threshold length of time, or a threshold amount of storage occupied by the set of first sub-indexes.

In some examples, the set of first sub-indexes and the second sub-index may be stored on a hard-disk drive. In other examples, a size of each sub-index of the set of first sub-indexes may be equal to or less than a size of a portion of the memory allocated to store updates to the data table.

In some examples, the update to the row of the data table may include an addition of the row to the data table or a deletion of the row from the data table.

In some examples, the set of first sub-indexes may include a first set of entries that correspond to updates for adding rows to the data table and a second set of entries that correspond to updates for deleting rows from the data table. In other examples, updating the second sub-index may include: adding entries of the first set of entries to the second sub-index; and removing entries of the second set of entries from the second sub-index.

In some examples, the process may further include deleting the set of first sub-indexes after updating the second sub-index. In other examples, the process may further include searching the set of first sub-indexes and the second sub-index for a search key.

Systems and computer-readable storage medium for indexing data are also disclosed.

### BRIEF DESCRIPTION OF THE FIGURES

FIG. 1 illustrates an exemplary data table and associated index.

FIG. 2 illustrates an exemplary process for updating an index.

FIG. 3 illustrates an exemplary data table and associated composite index according to various embodiments.

FIG. 4 illustrates an exemplary process for indexing updates to a data table using a composite index according to various embodiments.

FIGS. 5-10 illustrate the indexing of updates to a data table using a composite index according to various embodiments.

FIG. 11 illustrates an exemplary process for updating a major sub-index of a composite index according to various embodiments.

FIGS. 12-13 illustrate the updating of an exemplary major sub-index of a composite index according to various embodiments.

FIG. 14 illustrates an exemplary process for searching a composite index according to various embodiments.

FIG. 15 illustrates an exemplary system for managing a composite index according to various examples.

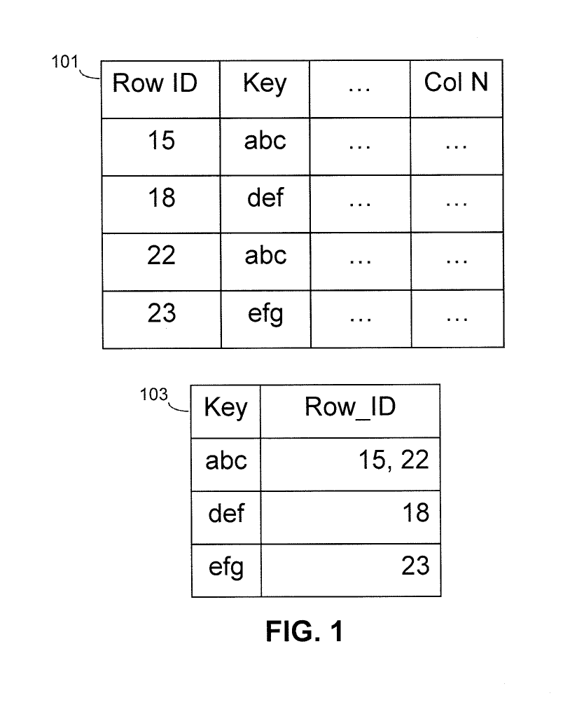

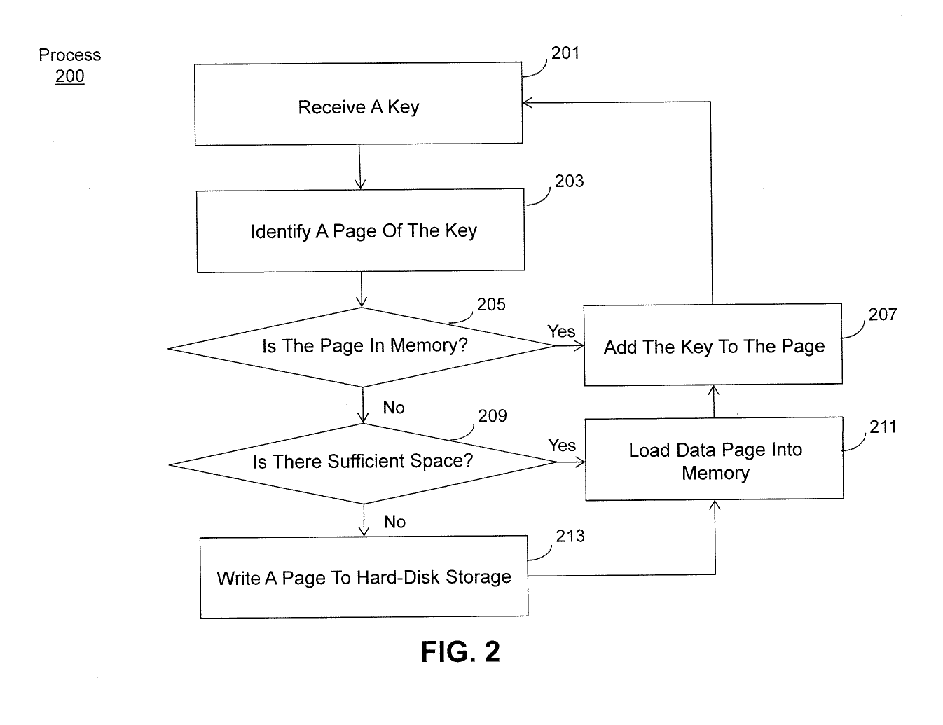

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various embodiments are described below relating to managing data using a composite index formed from a major sub-index and zero or more minor sub-indexes. Updates to the data may be cached in memory. When the cache memory becomes full, the contents of the cache may be sorted and stored as entries in a minor sub-index in a hard-disk drive with a single streaming disk write. In response to a threshold condition, the major sub-index may be updated using streaming disk accesses based on the entries in the minor sub-indexes. Once the major sub-index is updated to include all of the updates from the minor sub-indexes, the minor sub-indexes may be deleted.

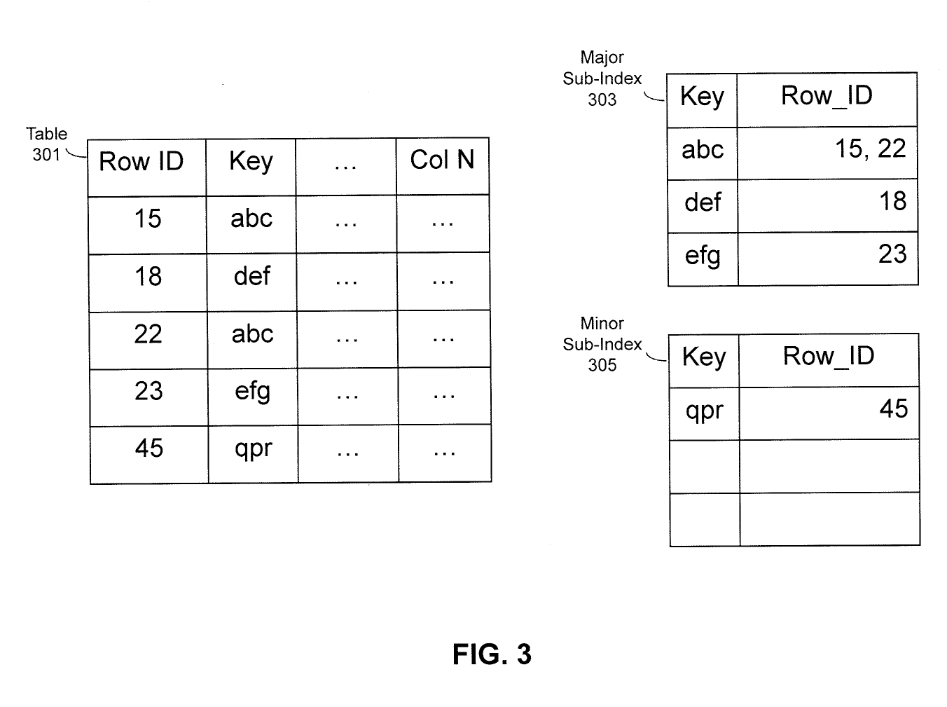

FIG. 3 illustrates an exemplary data table 301 and an associated composite index that may be used to index data contained in table 301, which may be similar or identical to table 101. Generally, the composite index may include a major sub-index 303 and one or more minor sub-indexes 305.

Updates to data table 301 may be cached in memory before being sorted and stored in hard-disk storage as a minor sub-index 305. Minor sub-index 305 may store updates to the data table 301 in the form of entries. In the example shown in FIG. 3, each entry (e.g., row) of minor sub-index 305 may correspond to a single update to data table 301. The first cell of each entry may include a key contained in an update to data table 301. The keys may include any type of data, such as numbers, characters, or a combination of numbers and characters. The second cell in each entry may include a unique identifier that identifies a storage location of the corresponding key in data table 301. For example, the unique identifier may be used to identify the file offset of the entry.

In some examples, as will be discussed in greater detail below, each minor sub-index may be designated as an add or delete sub-index indicating whether the entries contained in that minor sub-index correspond to additions or deletions being made to the data table. The designation may be represented by a single bit, a number, a character, a string of numbers and/or characters, or the like. For example, a “0” bit may indicate that the minor sub-index is designated as an add minor sub-index while a “1” bit may indicate that the minor sub-index is designated as a delete minor sub-index. As the cache used to store updates to data table 301 becomes filled with entries corresponding to updates made to data table 301, the contents of the cache may be sorted and stored as a new minor sub-index in order to accommodate the incoming updates to data table 301. The composite index may include any number of minor sub-indexes, but a threshold condition may be established to limit the maximum number of minor sub-indexes. The threshold condition may include a maximum number of minor sub-indexes, maximum amount of storage space occupied by the minor sub-indexes, a threshold length of time, or the like. As discussed in greater detail below, once the threshold condition is met, the minor sub-indexes may be collapsed into the major sub-index 303.

In some examples, the size of each minor sub-index may be equal to or less than the size of the memory available to the system for caching entries corresponding to updates made to the data table. For example, the size of each minor sub-index may be equal to or less than the size of the random access memory (RAM) allocated to serve as the cache for index entries because the entire cache may be output as a single minor sub-index. In these examples, the table updates currently being loaded may be stored in memory in the index-entry cache, while the minor sub-indexes and the major sub-index may be stored on a hard-disk storage medium. As the cache currently being written becomes full, the cache contents may be sorted and stored in hard-disk storage as a new minor sub-index. The cached entries may be deleted from memory, allowing a new cache of entries to be generated in memory.

As mentioned above, the composite index may further include one or more major sub-indexes 303 for associating keys with one or more rows of data table 301 containing those keys. As shown in FIG. 3, major sub-index 303 may include entries containing keys “abc,” “def,” and “efg.” Each key may be associated with a list of one or more identifiers of rows of data table 301. These lists of entries may include the unique identifiers (e.g., 15, 22, 18, and 23) corresponding to the rows in data table 301 having the associated key. In some examples, major sub-index 303 may be updated in response to the threshold condition of the minor sub-indexes. As will be described in greater detail below, during the update process, the entries stored in the minor sub-index 305 may be added to major sub-index 303 by adding/removing the unique identifiers of the rows of the minor sub-index 305 to/from the list of identifiers for the respective keys listed in major sub-index 303.

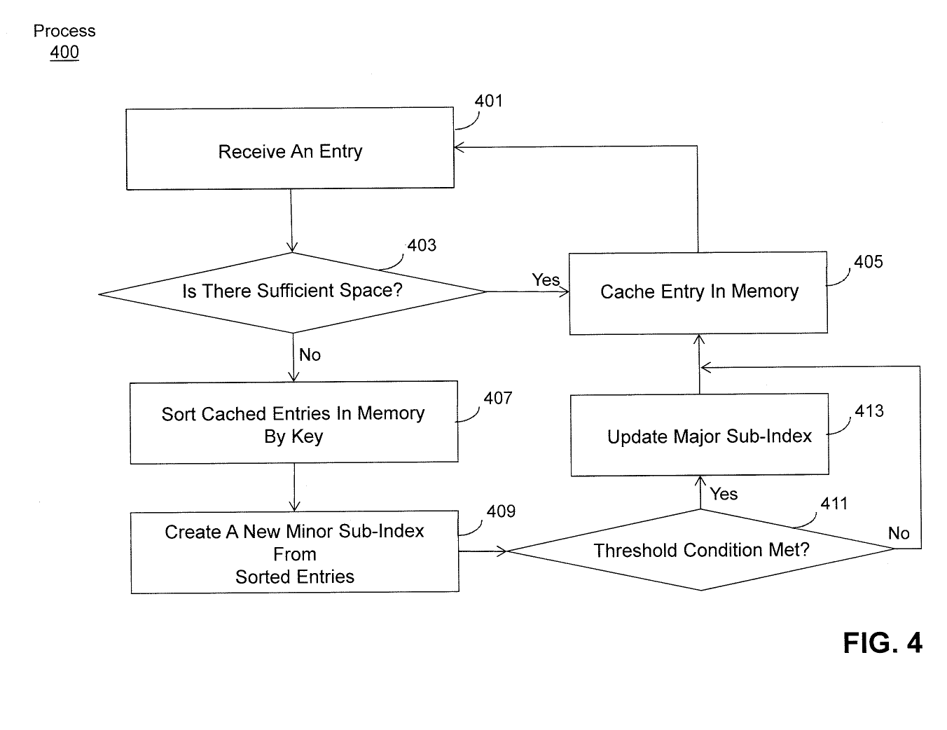

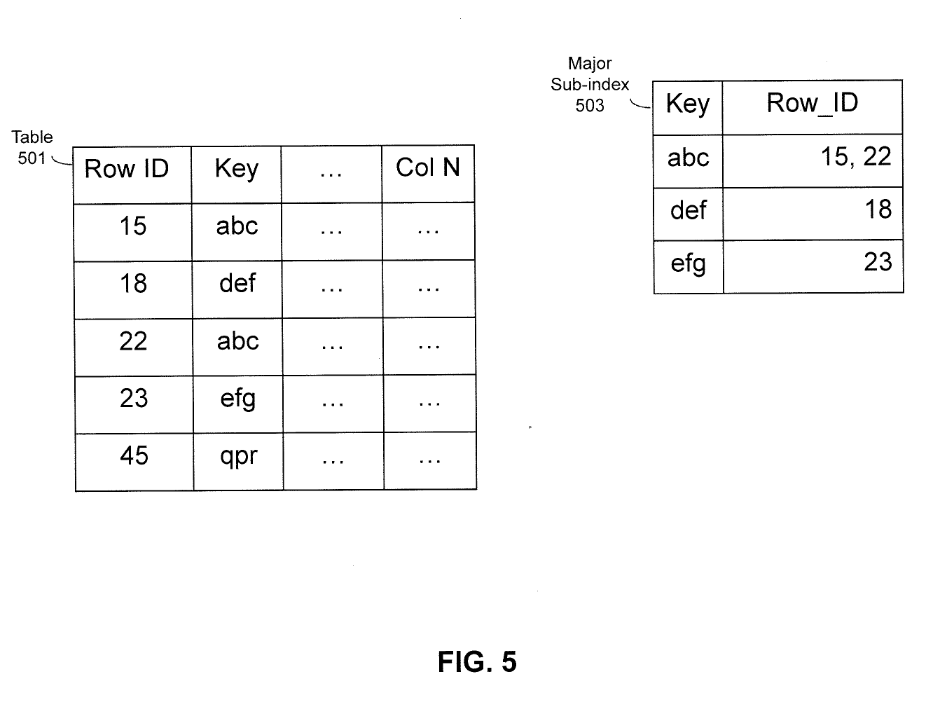

To illustrate the operation of the composite index, FIG. 4 illustrates an exemplary process 400 for indexing updates to a data table using a composite index according to various embodiments. At block 401, an entry associated with an update to a data table may be received. The entry may include a key and an associated unique identifier corresponding to the updated row in the data table. For example, as shown in FIG. 5, the key “qpr” may be added to table 501 in the row having Row ID 45. Thus, an entry having the key “qpr” and its associated Row ID 45 may be received.

At block 403, it may be determined if there is sufficient space in memory to store the entry that was received at block 401. For instance, continuing with the example provided above, it may be determined whether or not there is sufficient space in memory to store a mapping of the key “qpr” to Row ID 45. If there is sufficient space in memory, the process may proceed to block 405.

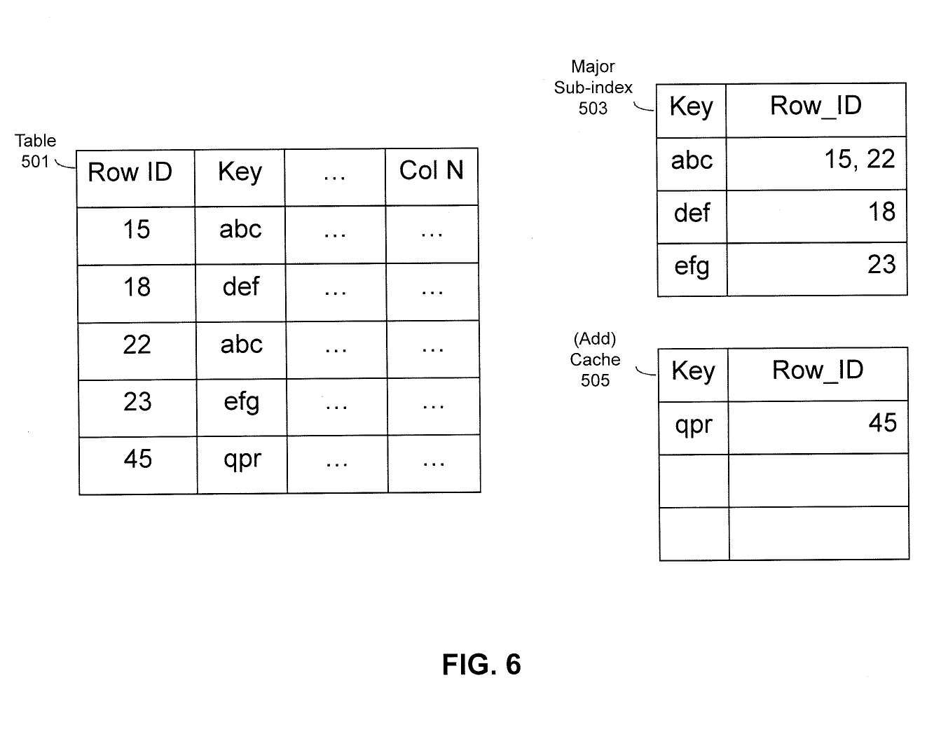

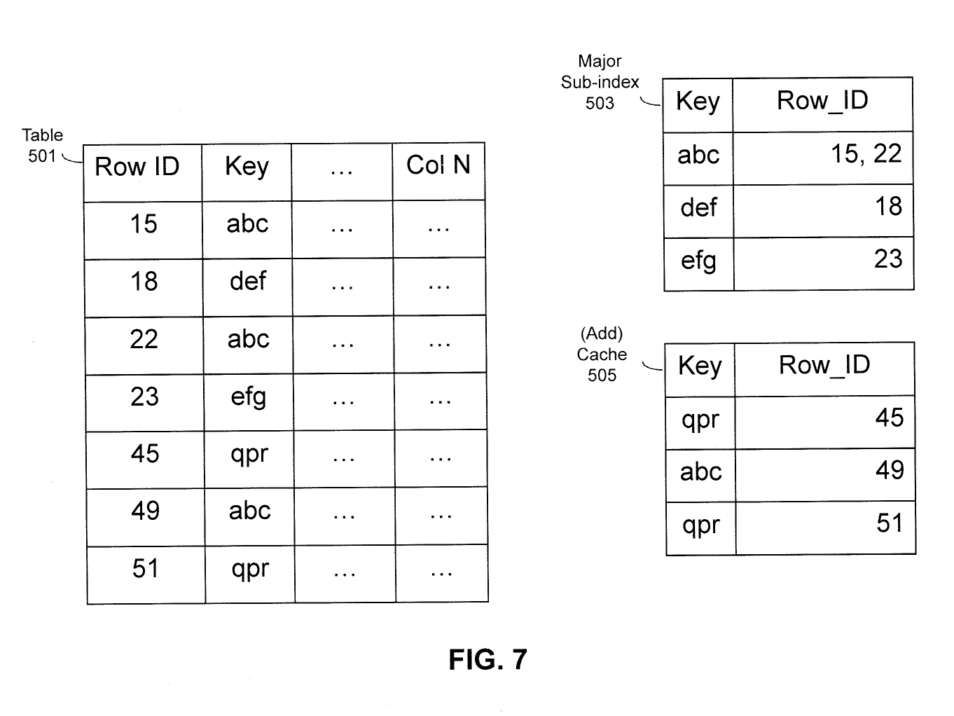

At block 405, the entry received at block 401 may be cached in memory by writing the entry to memory. For instance, continuing with the example provided above, FIG. 6 shows the caching of an entry that includes a mapping between the key “qpr,” which was recently added to table 501, and its associated Row ID 45 in table 501. Since cache 505 is being used to index additions to table 501, cache 505 may be designated as an add cache. Blocks 401, 403, and 405 may be repeated as updates are made to data table 501 until the memory storing the cached entries becomes full, for example, as shown in FIG. 7. In this example, rows 49 and 51 have been added to data table 501 and have been stored in cache 505 using blocks 401, 403, and 405.

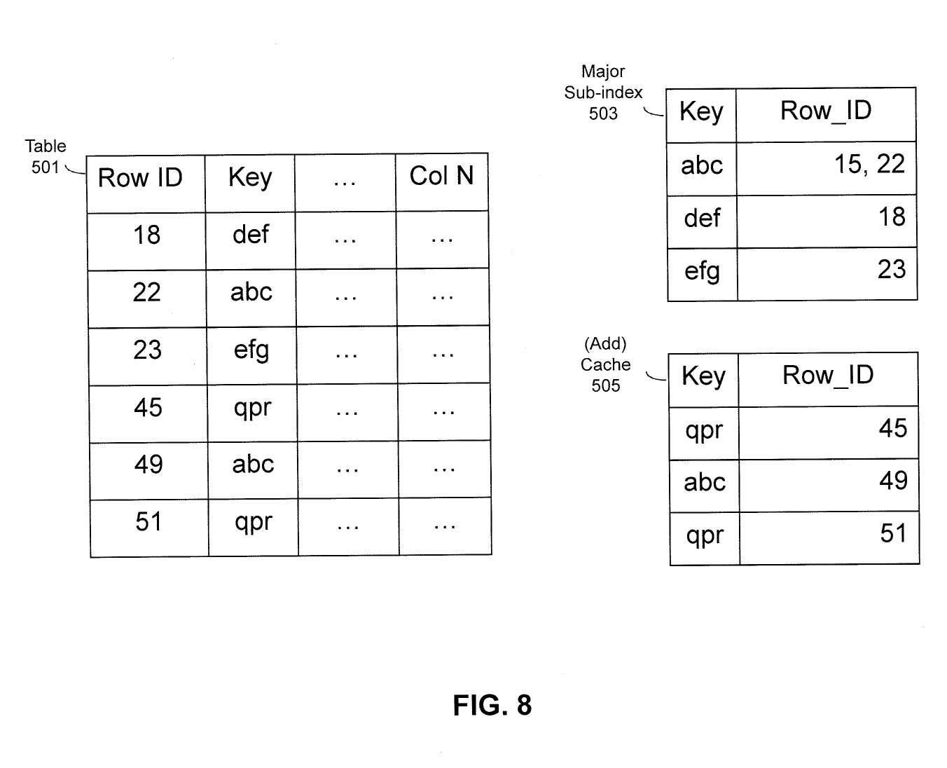

Once an entry is received and the memory is determined to contain insufficient space to store the new entry at block 403, the process may instead proceed to block 407. For example, as shown in FIG. 8, the row having Row ID 15 may be deleted from table 501. In this example, the cache 505 may be determined to lack sufficient space to store this update to table 501. Thus, the process may proceed to block 407. At block 407, the cached entries stored in cache 505 may be sorted by their associated keys (e.g., numerically, alphabetically, or the like). This sorting may be performed in memory to improve the speed of the sorting. For example, the entries in cache 505 may be sorted to list the entry containing key “abc” first, the entry containing key “qpr” and Row ID 45 second, and the entry containing key “qpr” and Row ID 51 third.

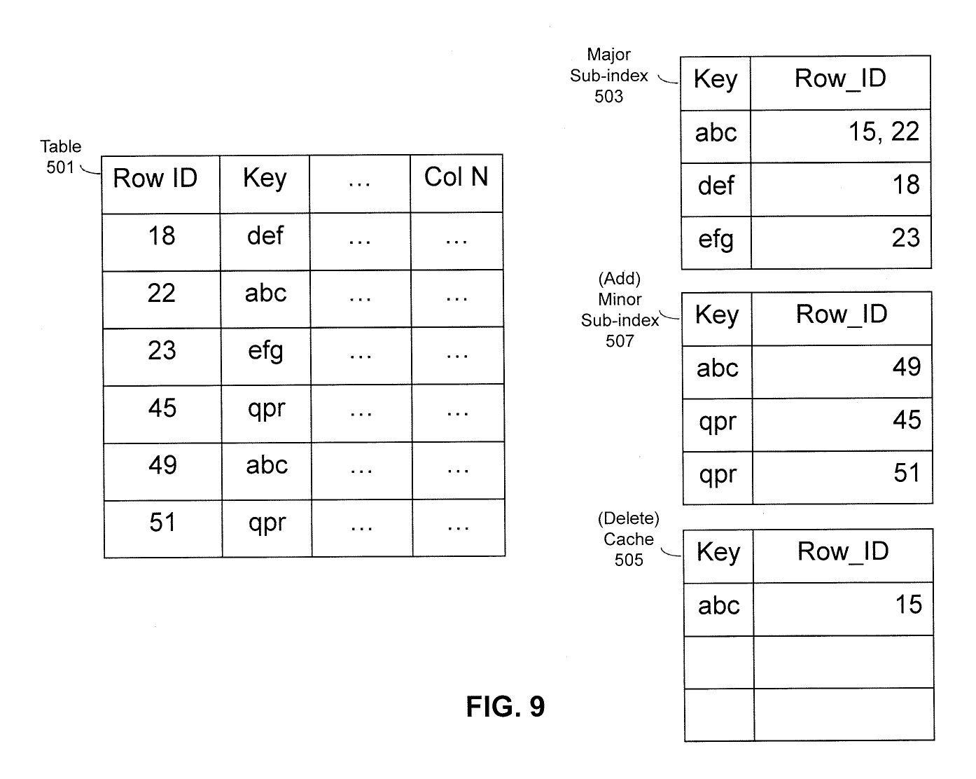

After sorting at block 407, process 400 may proceed to block 409 where the sorted cached data may be written from memory to hard-disk storage as a minor sub-index. The cached data may subsequently be deleted from memory. Once the minor sub-index is written to hard-disk, it may be determined whether or not a threshold condition for the minor sub-indexes has been reached at block 411. In some examples, the threshold condition may include a threshold number of minor sub-indexes that can be created, a threshold amount of storage being occupied by the minor sub-indexes, a threshold length of time since the first sub-index was created, or the like. For example, referring to FIG. 8, if the threshold condition is that the threshold number of minor sub-indexes that can be created is 2, it may be determined at block 411 that the threshold condition has not been met. Thus, a negative determination may be made at block 411 and the process may proceed to block 405, where the entry received at block 401 may be cached in the recently cleared memory. For example, FIG. 9 shows the minor sub-index 507 written to hard-disk storage at block 409 and the entry containing a mapping between key “abc” and Row ID 15 stored in cache 505. In this example, cache 505 may be designated as a deletion cache since it is being used to index deletions from table 501. Additionally, in this example, major sub-index 503 and minor sub-index 507 may be stored on hard-disk storage, while cache 505 may be stored in memory.

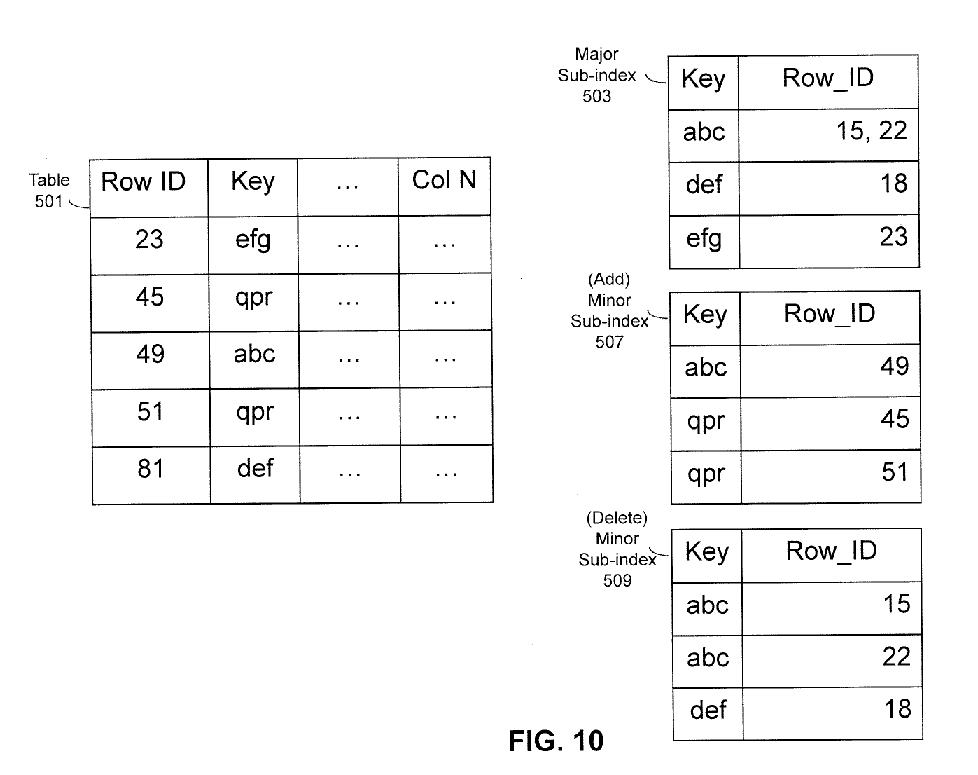

Process 400 may be repeated to index updates made to table 501 using blocks 401, 403, 405, 407, 409, and 411, as discussed above, until a threshold condition occurs for the minor sub-indexes. For example, as shown in FIG. 10, cache 505 may become full after being used to store updates to table 501 removing keys “def” and “abc” previously stored in rows 18 and 22, respectively. After an update adding key “def” at the row having Row ID 81 is made, the contents of cache 505 may be sorted at block 407 and written to hard-disk storage at block 409 as minor sub-index 509. In this example, when process 400 reaches block 411, it may be determined whether or not a threshold condition for the minor sub-indexes has been reached. If the threshold condition is that the threshold number of minor sub-indexes that can be created is 2, a positive determination may be made at block 411, causing process 400 to proceed to block 413.

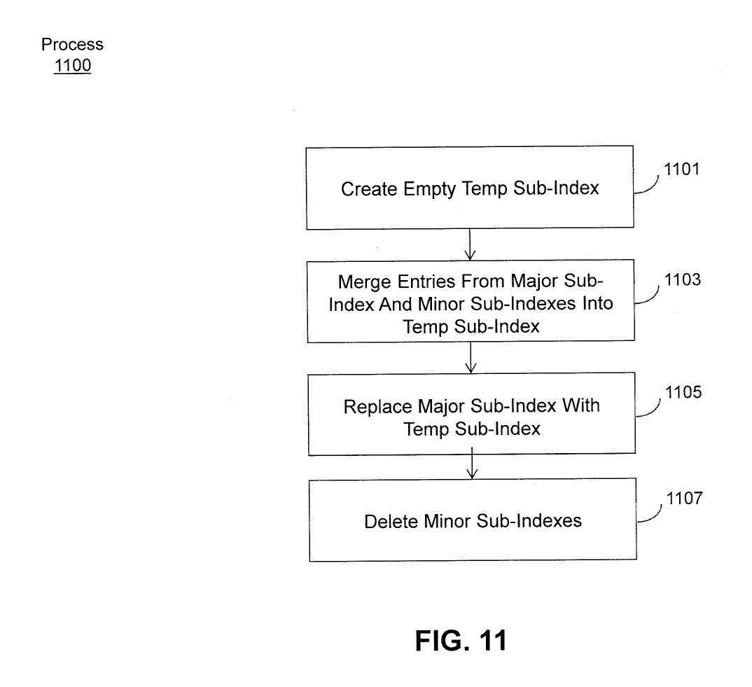

At block 413, the major sub-index may be updated based on the minor sub-indexes. FIG. 11 illustrates an exemplary process 1100 that may be used to update the major sub-index of a composite index according to various examples. At block 1101, an empty temporary sub-index may be generated. At block 1103, the entries of the major sub-index and the minor sub-indexes may be merged into the temporary sub-index generated at block 1101. The entries may be merged by sequentially evaluating each key contained in the sub-indexes. To evaluate each key, the key may be added to the temporary sub-index along with the Row IDs associated with the key in entries of the major sub-index and minor sub-indexes designated as additions. The Row IDs from the minor sub-indexes designated as deletions may be removed from the temporary sub-index. The keys may be evaluated in numerical, alphabetical, or another order. Additionally, the entries of the major sub-index may be processed first, with each entry being considered an addition, and the entries of the minor sub-indexes may be processed in the order in which they were created (earlier created sub-indexes processed first).

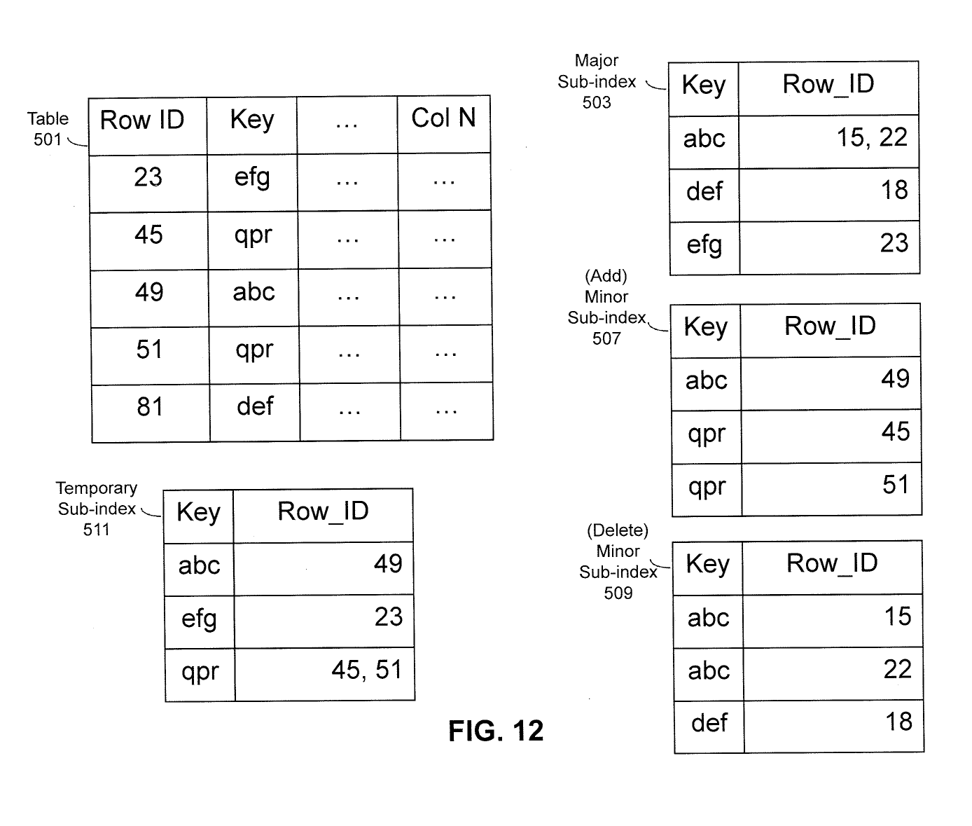

To illustrate the operation of block 1103, FIG. 12 shows temporary sub-index 511 after performing block 1103 to merge the contents of the major sub-index 503 and minor sub-indexes 507 and 509. In particular, the keys “abc,” “def,” and “efg” and their associated Row IDs (e.g., Row IDs 15 and 22, 18, and 23, respectively) from the major sub-index 503 were added to the temporary sub-index 511. Additionally, the Row IDs for the key “abc” in minor sub-index 507 (e.g., Row ID 49) was added to the list of Row IDs for the key “abc” in the temporary sub-index 511 since this sub-index is designated as an add sub-index. Since temporary sub-index 511 did not previously include the key “qpr,” this key may be added to temporary sub-index 511 and the Row IDs associated with this key (e.g., Row IDs 45 and 51) may be added to temporary sub-index 511. The process may be performed for each of the entries in each of the add minor sub-indexes in a similar fashion.

However, any entries contained in a delete minor sub-index, such as minor sub-index 509, may cause the unique identifiers associated with keys in the delete minor sub-index to be removed from the list of Row IDs for those keys in the temporary sub-index 511. For example, as shown in FIG. 12, the Row IDs for keys “abc” and “def” (e.g., Row IDs 15, 18, and 22) have been removed from the list of Row IDs for the corresponding keys in temporary sub-index 511. In some examples, if, after performing block 1103, there are no Row IDs in the list of Row IDs for a particular key, the key and associated list of Row IDs may be removed from the temporary sub-index 511 (e.g., key “def” has been removed in the example shown in FIG. 12). Alternatively, the key and associated list of Row IDs may remain in the major sub-index.

Referring back to FIG. 11, after each entry of the major sub-index and the minor sub-indexes have been merged into the temporary sub-index, the process may proceed to block 1105. At block 1105, the major sub-index may be replaced with the temporary sub-index and the temporary sub-index may be deleted. At block 1107, the minor sub-indexes may also be deleted from the hard-disk storage.

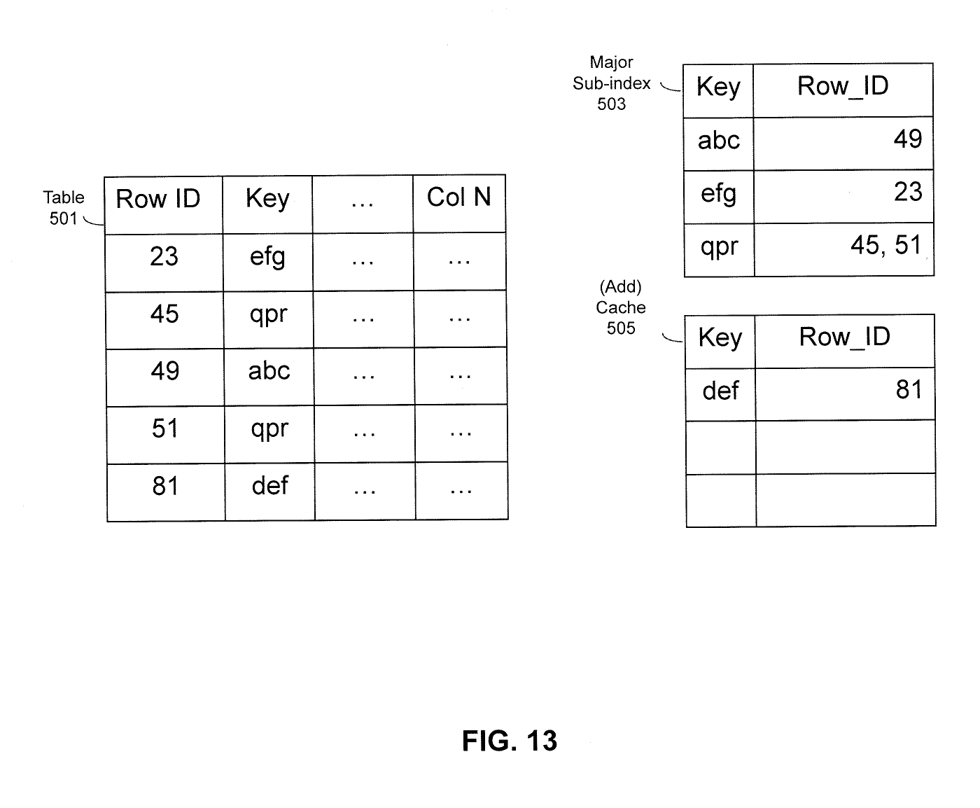

Referring back to FIG. 4, after updating the major sub-index at block 413, the process may proceed to block 405, where the entry received at block 401 may be cached in memory. FIG. 13 illustrates the composite index after performing blocks 413 (e.g., using process 1100) and 405.

Using processes 400 and 1100 described above, a composite index may be managed by caching updates (e.g., additions and deletions) to a data table in memory. The cached updates may be sorted and stored as minor sub-indexes on hard-disk storage once the memory becomes full. Since all writing to sub-indexes are done in batches, there is no need to reserve unused space for new entries within the sub-index, and sub-indexes can be implemented using any of a variety of well-known data structures optimized for compact storage, streaming writes, and fast lookups. Consequently, the total time spent reading and writing disk pages is reduced.

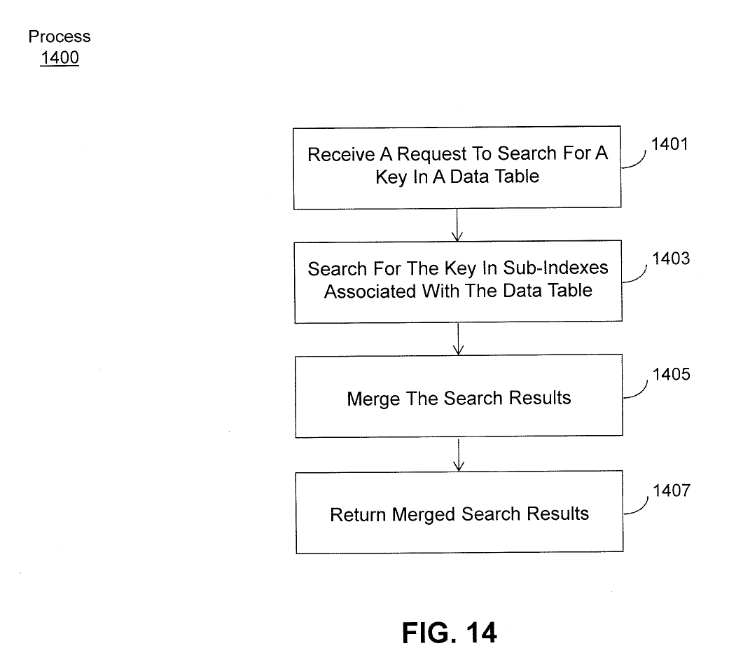

FIG. 14 illustrates an exemplary process 1400 for searching a composite index similar or identical to those described above. At block 1401, a request may be received to search for a key in a data table similar or identical to data table 501. At block 1403, the sub-indexes (e.g., major sub-index and all minor sub-indexes) of a composite index associated with the data table may be searched to locate the key. In some examples, the major sub-index may be searched first and the minor sub-indexes may be subsequently searched based on the order in which they were created. For example, using the example shown in FIG. 10, a request to search for key “abc” may be received at block 1401. At block 1403, major sub-index 503, minor sub-index 507, and minor sub-index 509 may be searched for key “abc.” The result of the search may include a first search result from major sub-index 503 containing Row IDs 15 and 22, a second search result from minor sub-index 507 containing Row ID 49 designated as an addition, and a third search result from minor sub-index 509 containing Row IDs 15 and 22 designated as deletions.

After searching the sub-indexes at block 1403, the process may proceed to block 1405. At block 1405, the search results produced at block 1403 may be merged. Merging may include generating a list of Row IDs based on the search results produced at block 1403 and their associated add/delete designations. For purposes of the merging performed at block 1405, the search results from the major sub-index may be considered as additions. The list may be generated by adding Row IDs contained in search results from add sub-indexes and removing Row IDs contained in search results from delete sub-indexes. The search result (if any) from the major sub-index may be processed first, followed by search results (if any) from the minor sub-indexes based on the order in which they were generated (with the earlier created sub-indexes processed first). For instance, continuing with the example provided above, the first search result from the major sub-index may include Row IDs 15 and 22. Thus, Row IDs 15 and 22 may be added to the merged list, which may now contain Row IDs 15 and 22. The second search result from minor sub-index 507 may include Row ID 49 designated as an addition. Thus, Row ID 49 may be added to the merged list, which may now contain Row IDs 15, 22, and 49. The third search result from minor sub-index 509 may include Row IDs 15 and 22 designated as deletions. Thus, Row IDs 15 and 22 may be removed from the merged list, which may now contain Row ID 49.

Once the search results are merged at block 1405, the merged list of search results may be returned at block 1407. Continuing with the example above, the merged list of search results contains Row ID 49, which may be returned to the user to identify the occurrences of the key “abc” in data table 501.

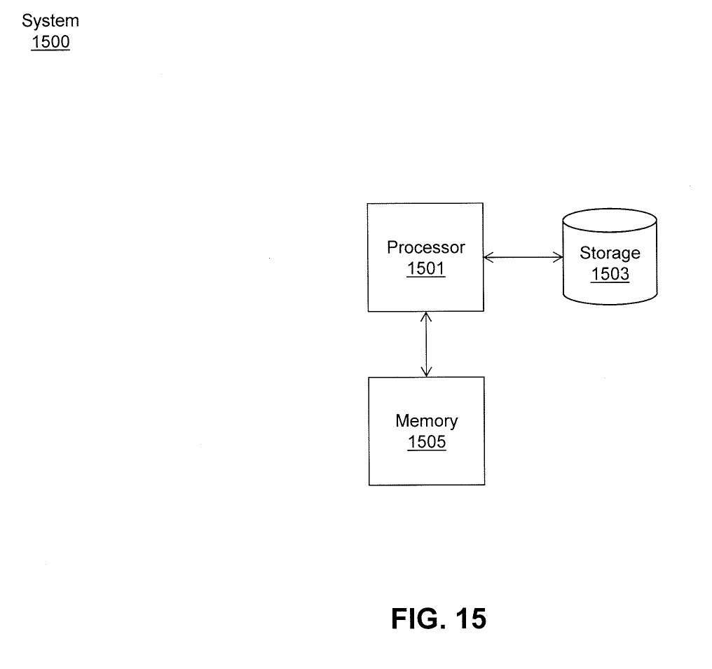

FIG. 15 illustrates a block diagram of exemplary system 1500 for managing a composite index according to various examples. System 1500 may include a processor 1501 for performing some or all of the processes described above, such as processes 400, 1100, and 1400. Processor 1501 may be coupled to storage 1503, which may include a hard-disk drive or other large capacity storage device. In some examples, the major sub-index and minor sub-indexes of a composite index may be stored in storage 1503. System 1500 may further include memory 1505, such as a random access memory. In some examples, the updates to a data table may be cached in at least a portion of memory 1505.

In some examples, a non-transitory computer-readable storage medium can be used to store (e.g., tangibly embody) one or more computer programs for performing any one of the above-described processes by means of a computer. The computer program may be written, for example, in a general purpose programming language (e.g., Pascal, C, C++) or some specialized application-specific language. The non-transitory computer-readable medium may include storage 1503, memory 1505, embedded memory within processor 1501, an external storage device (not shown), or the like.

Although only certain exemplary embodiments have been described in detail above, those skilled in the art will readily appreciate that many modifications are possible in the exemplary embodiments without materially departing from the novel teachings and advantages of this disclosure. For example, aspects of embodiments disclosed above can be combined in other combinations to form additional embodiments. Accordingly, all such modifications are intended to be included within the scope of this disclosure.

What is claimed is:

1. A computer-implemented method for indexing data, wherein the data is stored as a plurality of rows in a data table, the method comprising:
storing, in a memory, an update to a row of a data table, wherein the update to the row of the data table is stored as an entry comprising a key and a row identifier associated with the row;
sorting a plurality of entries stored in the memory in response to a first threshold condition, wherein the plurality of entries comprises the entry;
storing the sorted plurality of entries as a first sub-index; and
updating a second sub-index based on a set of first sub-indexes in response to a second threshold condition, wherein the set of first sub-indexes comprises the first sub-index.

2. The computer-implemented method of claim 1, wherein after updating the second sub-index based on the set of first sub-indexes, the second sub-index comprises:
a plurality of keys contained in the data table; and
one or more lists of row identifiers associated with plurality of keys, wherein the one or more lists of row identifiers comprise row identifiers corresponding to the rows of the data table that include the plurality of keys.

3. The computer-implemented method of claim 1, wherein the first threshold condition comprises insufficient space in the memory to store the update.

4. The computer-implemented method of claim 1, wherein the second threshold condition comprises a threshold number of sub-indexes in the set of first sub-indexes, a threshold length of time, or a threshold amount of storage occupied by the set of first sub-indexes.

5. The computer-implemented method of claim 1, wherein the set of first sub-indexes and the second sub-index are stored on a hard-disk drive.

6. The computer-implemented method of claim 1, wherein a size of each sub-index of the set of first sub-indexes is equal to or less than a size of a portion of the memory allocated to store updates to the data table.

7. The computer-implemented method of claim 1, wherein the update to the row of the data table comprises an addition of the row to the data table or a deletion of the row from the data table.

8. The computer-implemented method of claim 1, wherein the set of first sub-indexes comprises a first set of entries that correspond to updates for adding rows to the data table and a second set of entries that correspond to updates for deleting rows from the data table.

9. The computer-implemented method of claim 8, wherein updating the second sub-index comprises:
adding entries of the first set of entries to the second sub-index; and
removing entries of the second set of entries from the second sub-index.

10. The computer-implemented method of claim 1, further comprising deleting the set of first sub-indexes after updating the second sub-index.

11. The computer-implemented method of claim 1, further comprising searching the set of first sub-indexes and the second sub-index for a search key.

12. A system for indexing data, wherein the data is stored as a plurality of rows in a data table, the system comprising:
a memory; and
a processor configured to:
store, in the memory, an update to a row of a data table, wherein the update to the row of the data table is stored as an entry comprising a key and a row identifier associated with the row;
sort a plurality of entries stored in the memory in response to a first threshold condition, wherein the plurality of entries comprises the entry;
store the sorted plurality of entries as a first sub-index; and
update a second sub-index based on a set of first sub-indexes in response to a second threshold condition, wherein the set of first sub-indexes comprises the first sub-index.

13. The system of claim 12, wherein the first threshold condition comprises insufficient space in the memory to store the update.

14. The system of claim 12, wherein the second threshold condition comprises a threshold number of sub-indexes in the set of first sub-indexes, a threshold length of time, or a threshold amount of storage occupied by the set of first sub-indexes.

15. The system of claim 12, further comprising a hard-disk drive, wherein the set of first sub-indexes and the second sub-index are stored on the hard-disk drive.

16. The system of claim 12, wherein the set of first sub-indexes comprises a first set of entries that correspond to updates for adding rows to the data table and a second set of entries that correspond to updates for deleting rows from the data table.

17. The system of claim 12, wherein the processor is further configured to search the set of first sub-indexes and the second sub-index for a search key.

18. A non-transitory computer-readable storage medium comprising program code for indexing data, wherein the data is stored as a plurality of rows in a data table, the program code for:
storing, in a memory, an update to a row of a data table, wherein the update to the row of the data table is stored as an entry comprising a key and a row identifier associated with the row;
sorting a plurality of entries stored in the memory in response to a first threshold condition, wherein the plurality of entries comprises the entry;
storing the sorted plurality of entries as a first sub-index; and
updating a second sub-index based on a set of first sub-indexes in response to a second threshold condition, wherein the set of first sub-indexes comprises the first sub-index.

19. The non-transitory computer-readable storage medium of claim 18, wherein the first threshold condition comprises insufficient space in the memory to store the update.

20. The non-transitory computer-readable storage medium of claim 18, wherein the second threshold condition comprises a threshold number of sub-indexes in the set of first sub-indexes, a threshold length of time, or a threshold amount of storage occupied by the set of first sub-indexes.

21. The non-transitory computer-readable storage medium of claim 18, wherein the set of first sub-indexes and the second sub-index are stored on a hard-disk drive.

22. The non-transitory computer-readable storage medium of claim 18, wherein a size of each sub-index of the set of first sub-indexes is equal to or less than a size of a portion of the memory allocated to store updates to the data table.

23. The non-transitory computer-readable storage medium of claim 18, wherein the set of first sub-indexes comprises a first set of entries that correspond to updates for adding rows to the data table and a second set of entries that correspond to updates for deleting rows from the data table.

24. The non-transitory computer-readable storage medium of claim 18, further comprising program code for searching the set of first sub-indexes and the second sub-index for a search key.
